(19) United States
(12) Patent Application Publication
(10) Pub. No.: US 2014/0017494 A1
(43) Pub. Date: Jan. 16, 2014

(54) INSULATIONS CONTAINING NON-MIGRATING ANTISTATIC AGENT

(71) Applicant: General Cable Technologies Corporation, Highland Heights, KY (US)

(72) Inventors: Jianmin LIU, Carmel, IN (US); Vijay MHETAR, Westfield, IN (US); Sean W. CULLIGAN, Zionsville, IN (US)

(73) Assignee: General Cable Technologies Corporation, Highland Heights, KY (US)

(21) Appl. No.: 13/938,961

(22) Filed: Jul. 10, 2013

Related U.S. Application Data
(60) Provisional application No. 61/670,844, filed on Jul. 12, 2012.

(51) Int. Cl. H01B 3/44

(52) U.S. Cl. CPC H01B 3/441
USPC 428/379; 524/331; 524/102

(57) ABSTRACT

The invention provides an insulation composition for an electric cable containing a polyolefin, a permanent (non-migrating) antistatic agent, a phenolic antioxidant, and a peroxide. Preferably, the permanent antistatic agent is present at about 0.5-5 percent by weight of the total composition, preferably about 0.8-3 percent, and more preferably about 0.9-2.5 percent.

The present invention claims the priority of U.S. Provisional Patent Application No. 61/670,844, filed Jul. 12, 2012, which is incorporated herein by reference.

### FIELD OF THE INVENTION

The invention relates to cover (insulation or jacket) compositions for electric cables having a polyolefin and a permanent antistatic agent.

### BACKGROUND OF THE INVENTION

Typical power cables generally have one or more conductors in a core that is surrounded by several layers that can include: a first polymeric semiconducting shield layer, a polymeric insulating layer, a second polymeric semiconducting shield layer, a metallic tape shield and a polymeric jacket.

Polymeric materials have been utilized in the past as electrical insulating and semiconducting shield materials for power cables. In services or products requiring long-term performance of an electrical cable, such polymeric materials, in addition to having suitable dielectric properties, must be durable. For example, polymeric insulation utilized in building wire, electrical motor or machinery power wires, or underground power transmitting cables, must be durable for safety and economic necessities and practicalities.

One major type of failure that polymeric power cable insulation can undergo is the phenomenon known as treeing. Treeing generally progresses through a dielectric section under electrical stress so that, if visible, its path looks something like a tree. Treeing may occur and progress slowly by periodic partial discharge. It may also occur slowly in the presence of moisture without any partial discharge, or it may occur rapidly as the result of an impulse voltage. Trees may form at the site of a high electrical stress such as contaminants or voids in the body of the insulation-semiconductive screen interface. In solid organic dielectrics, treeing is the most likely mechanism of electrical failures which do not occur catastrophically, but rather appear to be the result of a more lengthy process. In the past, extending the service life of polymeric insulation has been achieved by modifying the polymeric materials by blending, grafting, or copolymerization of silane-based molecules or other additives so that either trees are initiated only at higher voltages than usual or grow more slowly once initiated.

There are two kinds of treeing known as electrical treeing and water treeing. Electrical treeing results from internal electrical discharges that decompose the dielectric. High voltage impulses can produce electrical trees. The damage, which results from the application of high alternating current voltages to the electrode/insulation interfaces, which can contain imperfections, is commercially significant. In this case, very high, localized stress gradients can exist and with sufficient time can lead to initiation and growth of trees. An example of this is a high voltage power cable or connector with a rough interface between the conductor or conductor shield and the primary insulator. The failure mechanism involves actual breakdown of the modular structure of the dielectric material, perhaps by electron bombardment. In the past much of the art has been concerned with the inhibition of electrical trees.

In contrast to electrical treeing, which results from internal electrical discharges that decompose the dielectric, water treeing is the deterioration of a solid dielectric material, which is simultaneously exposed to liquid or vapor and an electric field. Buried power cables are especially vulnerable to water treeing. Water trees initiate from sites of high electrical stress such as rough interfaces, protruding conductive points, voids, or imbedded contaminants, but at lower voltages than that required for electrical trees. In contrast to electrical trees, water trees have the following distinguishing characteristics; (a) the presence of water is essential for their growth; (b) no partial discharge is normally detected during their growth; (c) they can grow for years before reaching a size that may contribute to a breakdown; (d) although slow growing, they are initiated and grow in much lower electrical fields than those required for the development of electrical trees.

Electrical insulation applications are generally divided into low voltage insulation (less than 1 K volts), medium voltage insulation (ranging from 1 K volts to 69 K volts), and high voltage insulation (above 69 K volts). In low voltage applications, for example, electrical cables and applications in the automotive industry treeing is generally not a pervasive problem. For medium-voltage applications, electrical treeing is generally not a pervasive problem and is far less common than water treeing, which frequently is a problem. The most common polymeric insulators are made from either polyethylene homopolymers or ethylene-propylene elastomers, otherwise known as ethylene-propylene-rubber (EPR) or ethylene-propylene-diene ter-polymer (EPDM).

Polyethylene is generally used neat (without a filler) as an electrical insulation material. Polyethylenes have very good dielectric properties, especially dielectric constants and power factors. The dielectric constant of polyethylene is in the range of about 2.2 to 2.3. The power factor, which is a function of electrical energy dissipated and lost and should be as low as possible, is around 0.0002 at room temperature, a very desirable value. The mechanical properties of polyethylene polymers are also adequate for utilization in many applications as medium-voltage insulation, although they are prone to deformation at high temperatures. However, polyethylene homopolymers are very prone to water treeing, especially toward the upper end of the medium-voltage range.

There have been attempts to make polyethylene-based polymers that would have long-term electrical stability. For example, when dicumyl peroxide is used as a crosslinking agent for polyethylene, the peroxide residue functions as a tree inhibitor for some time after curing. However, these residues are eventually lost at most temperatures where electrical power cable is used. U.S. Pat. No. 4,144,202 issued Mar. 13, 1979 to Ashcraft, et al. discloses the incorporation into polyethylenes of at least one epoxy containing organo-silane as a treeing inhibitor. However, a need still exists for a polymeric insulator having improved treeing resistance over such silane containing polyethylenes.

Unlike polyethylene, which can be utilized neat, the other common medium-voltage insulator, EPR, typically contains a high level of filler in order to resist treeing. When utilized as a medium-voltage insulator, EPR will generally contain about 20 to about 50 weight percent filler, most likely calcined clay, and is preferably crosslinked with peroxides. The presence of the filler gives EPR a high resistance against the propagation of trees. EPR also has mechanical properties which are superior to polyethylene at elevated temperatures. EPR is also much more flexible than polyethylene, which can be an advantage for tight space or difficult installations.

Unfortunately, while the fillers utilized in EPR may help prevent treeing, the filled EPR will generally have poor dielectric properties, i.e. a poor dielectric constant and a poor power factor. The dielectric constant of filled EPR is in the range of about 2.3 to about 2.8. Its power factor is on the order of about 0.002 to about 0.005 at room temperature, which is approximately an order of magnitude worse than polyethylene.

Thus, both polyethylenes and EPR have serious limitations as an electrical insulator in cable applications. Although polyethylene polymers have good electric properties, they have poor water tree resistance. While filled EPR has good treeing resistance and good mechanical properties, it has dielectric properties inferior to polyethylene polymers.

Polyethylene glycol (PEG) has also been used to prevent treeing in the insulation. For example, U.S. Pat. No. 4,612,139 used PEG in a semiconductive layer that is bonded to an insulation layer of an electrical cable, serving to protect the insulation from water trees. However, PEG tends to deteriorate over time due to migration to the surface.

Therefore, a need exists in the electrical cable industry for a polyolefin insulation system that provides improved dielectric properties as well as reduced treeing.

### SUMMARY OF THE INVENTION

The invention provides an insulation composition for an electric cable containing a polyolefin, a permanent (non-migrating) antistatic agent, a phenolic antioxidant, and a peroxide. Preferably, the permanent antistatic agent is present at about 0.5-5 percent by weight of the total composition, preferably about 0.8-3 percent, and more preferably about 0.9-2.5 percent. The preferred antistatic agents is polyethylene-polyether copolymer, potassium ionomer, ethoxylated amine, or polyether block imides. The preferred phenolic antioxidant is thiodiethylene bis(3-(3,5-di-tert-4-butyl-4-hydroxyphenyl)propionate, pentaerythritol tetrakis(3-(3,5-di-tert-butyl-4-hydroxyphenyl)propionate, ethylenebis(oxyethylene)bis-(3-(5-tert-butyl-4-hydroxy-m-tolyl)-propionate, or 4,6-bis(octylthiomethyl)o-cresol. The preferred peroxide is dicumyl peroxide or tert-butyl cumyl peroxide. The composition can also contain antioxidants, stabilizers, fillers, peroxide, etc. The preferred polyolefin is LDPE.

The invention also provides an electric cable containing an electrical conductor surrounded by an insulation. The insulation contains a polyolefin, a permanent antistatic agent, a phenolic antioxidant, and a peroxide. The cable can also contain at least one shield layer and jacket as known in the art.

The invention also provides a method of making a tree resistant cable cover (insulation or jacket) containing a polyolefin and a nano filler.

### DETAIL DESCRIPTION OF THE PREFERRED EMBODIMENTS

The invention provides a cover (insulation or jacket) composition for an electric cable containing a polyolefin, a permanent antistatic agent, a phenolic antioxidant, and a peroxide. The permanent antistatic agent is present at about 0.5-5 percent by weight of the total composition, preferably about 0.8-3percent, and more preferably about 0.9-2.5 percent. The preferred composition contains about 90-99 percent polyolefin, about 0.5-5 percent permanent antistatic agent, about 0.2-1.5 percent phenolic antioxidant, and about 1.5-2.5 percent peroxide

Polyolefins, as used herein, are polymers produced from alkenes having the general formula CₙH₂ₙ. In embodiments of the invention, the polyolefin is prepared using a conventional Ziegler-Natta catalyst. In preferred embodiments of the invention the polyolefin is selected from the group consisting of a Ziegler-Natta polyethylene, a Ziegler-Natta polypropylene, a copolymer of Ziegler-Natta polyethylene and Ziegler-Natta polypropylene, and a mixture of Ziegler-Natta polyethylene and Ziegler-Natta polypropylene. In more preferred embodiments of the invention the polyolefin is a Ziegler-Natta low density polyethylene (LDPE) or a Ziegler-Natta linear low density polyethylene (LLDPE) or a combination of a Ziegler-Natta LDPE and a Ziegler-Natta LLDPE.

In other embodiments of the invention the polyolefin is prepared using a metallocene catalyst. Alternatively, the polyolefin is a mixture or blend of Ziegler-Natta and metallocene polymers.

The polyolefins utilized in the insulation composition for electric cable in accordance with the invention may also be selected from the group of polymers consisting of ethylene polymerized with at least one co-monomer selected from the group consisting of C₃ to C₂₀ alpha-olefins and C₃ to C₂₀ polyenes. Generally, the alpha-olefins suitable for use in the invention contain in the range of about 3 to about 20 carbon atoms. Preferably, the alpha-olefins contain in the range of about 3 to about 16 carbon atoms, most preferably in the range of about 3 to about 8 carbon atoms. Illustrative non-limiting examples of such alpha-olefins are propylene, 1-butene, 1-pentene, 1-hexene, 1-octene and 1-dodecene.

The polyolefins utilized in the insulation composition for electric cables in accordance with the invention may also be selected from the group of polymers consisting of either ethylene/alpha-olefin copolymers or ethylene/alpha-olefin/diene terpolymers. The polyene utilized in the invention generally has about 3 to about 20 carbon atoms. Preferably, the polyene has in the range of about 4 to about 20 carbon atoms, most preferably in the range of about 4 to about 15 carbon atoms. Preferably, the polyene is a diene, which can be a straight chain, branched chain, or cyclic hydrocarbon diene. Most preferably, the diene is a non conjugated diene. Examples of suitable dienes are straight chain acyclic dienes such as: 1,3-butadiene, 1,4-hexadiene and 1,6-octadiene; branched chain acyclic dienes such as: 5-methyl-1,4-hexadiene, 3,7-dimethyl-1,6-octadiene, 3,7 -dimethyl-1,7-octadiene and mixed isomers of dihydro myricene and dihydroocinene; single ring alicyclic dienes such as: 1,3-cyclopentadiene, 1,4-cylcohexadiene, 1,5-cyclooctadiene and 1,5-cyclododecadiene; and multi-ring alicyclic fused and bridged ring dienes such as: tetrahydroindene, methyl tetrahydroindene, dicylcopentadiene, bicyclo-(2,2,1)-hepta-2-5-diene; alkenyl, alkylidene, cycloalkenyl and cycloalkylidene norbornenes such as 5-methylene-2morbornene (MNB), 5-propenyl-2-norbornene, 5-isopropylidene-2-norbornene, 5-(4-cyclopentenyl)-2-norbornene, 5-cyclohexylidene-2-norbornene, 5-vinyl-2-norbornene and norbornene. Of the dienes typically used to prepare EPR's, the particularly preferred dienes are 1,4-hexadiene, 5-ethylidene-2-norbornene, 5-vinyllidene-2-norbornene, 5-methylene-2-norbornene and dicyclopentadiene. The especially preferred dienes are 5-ethylidene-2-norbornene and 1,4-hexadiene.

As an additional polymer in the polyolefin composition, a non-metallocene polyolefin may be used having the structural formula of any of the polyolefins or polyolefin copolymers described above. Ethylene-propylene rubber (EPR), polyethylene, polypropylene may all be used in combination with the Zeigler Natta and/or metallocene polymers.

In embodiments of the invention, the polyolefin contains 30% to 50% by weight Zeigler Natta polymer or polymers and 50% to 70% by weight metallocene polymer or polymers The total amount of additives in the treeing resistant “additive package” are from about 0.5% to about 4.0% by weight of said composition, preferably from about 1.0% to about 2.5% by weight of said composition.

A number of catalysts have been found for the polymerization of olefins. Some of the earliest catalysts of this type resulted from the combination of certain transition metal compounds with organometallic compounds of Groups I, II, and III of the Periodic Table. Due to the extensive amounts of early work done by certain research groups, many of the catalysts of that type came to be referred to by those skilled in the area as Ziegler-Natta type catalysts. The most commercially successful of the so-called Ziegler-Natta catalysts have heretofore generally been those employing a combination of a transition metal compound and an organoaluminum compound.

Metallocene polymers are produced using a class of highly active olefin catalysts known as metallocenes, which for the purposes of this application are generally defined to contain one or more cyclopentadienyl moiety. The manufacture of metallocene polymers is described in U.S. Pat. No. 6,270,856 to Hendewerk, et al, the disclosure of which is incorporated by reference in its entirety.

Metallocenes are well known, especially in the preparation of polyethylene and copolyethylene-alpha-olefins. Those catalysts, particularly those based on Group IV transition metals, zirconium, titanium and hafnium, show extremely high activity in ethylene polymerization. Various forms of the catalyst system of the metallocene type may be used for polymerization to prepare the polymers used in this invention, including but not limited to those of the homogeneous, supported catalyst type, wherein the catalyst and cocatalyst are together supported or reacted together onto an inert support for polymerization by a gas phase process, high pressure process, or a slurry, solution polymerization process. The metallocene catalysts are also highly flexible in that, by manipulation of the catalyst composition and reaction conditions, they can be made to provide polyolefins with controllable molecular weights from as low as about 200 (useful in applications such as lube-oil additives) to about 1 million or higher, as for example in ultra-high molecular weight linear polyethylene. At the same time, the MWD of the polymers can be controlled from extremely narrow (as in a polydispersity of about 2), to broad (as in a polydispersity of about 8).

Exemplary of the development of these metallocene catalysts for the polymerization of ethylene are U.S. Pat. No. 4,937,299 and EP-A-0 129 368 to Ewen, et al., U.S. Pat. No. 4,808,561 to Welborn, Jr., and U.S. Pat. No. 4,814,310 to Chang, all of which are incorporated herein by reference. Among other things, Ewen, et al. teaches that the structure of the metallocene catalyst includes an alumoxane, formed when water reacts with trialkyl aluminum. The alumoxane complexes with the metallocene compound to form the catalyst. Welborn, Jr. teaches a method of polymerization of ethylene with alpha-olefins and/or diolefins. Chang teaches a method of making a metallocene alumoxane catalyst system utilizing the absorbed water in a silica gel catalyst support. Specific methods for making ethylene/alpha-olefin copolymers, and ethylene/alpha-olefin/diene terpolymers are taught in U.S. Pat. Nos. 4,871,705 and 5,001,205 to Hoel, et al., and in EP-A-0 347 129, respectively, all of which are hereby fully incorporated by reference.

The preferred polyolefin is LDPE and blends thereof. It is preferred that the polyolefin is present at about 90-99 percent by weight of the total composition, preferably about 93-98 percent; and more preferably about 95-98 percent.

The permanent (non-migrating) antistatic agent is present at about 0.5-5 percent by weight of the total composition, preferably about 0.8-3 percent, and more preferably about 0.9-2.5 percent. “Permanent antistatic agent,” as used herein, refers to agents that reduce static built-up when objects are moved against each other, and that do not migrate within the polyolefin. The permanent antistatic agent (PAA) preferably distributes homogeneously in the polyolefin without migrating to the surface. PAAs are well-known in the art and are usually relatively high molecular weight polymers (e.g. copolyamindes, copolyesters, and ionomers). Appropriate PAAs for the present invention include, but are not limited to, inonic polymers, polyethylene-polyether copolymer (e.g., polyethylene glycol), potassium ionomer, ethoxylated amine, and polyether block imides. U.S. Pat. No. 7,825,191 to Morris et al., which is incorporated herein by reference, also discloses an ionomer permanent antistatic agent that can be use with the present invention. Commercially available PAAs include, for example, Irgastat™ P18 from Ciba Specialty Chemicals; LR-92967 from Ampacet, Tarrytown, N.Y.; Pelestat™ NC6321 and Pelestat™ NC7530 from Tomen America Inc., New York, N.Y; Stat-Rite™ from by Noveon, Inc., Cleveland, Ohio; Pelestat™ 300 available from Sanyo Chemicals; Pelestat™ 303, Pelestat™ 230, Pelestat˜ 6500, Statrite M809 available from Noveon; and Stat-Rite™ x5201, Stat-Rite™ x5202, Irgastat™ P16 available from Ciba Chemicals.

Any suitable phenolic antioxidant may be used in accordance with the invention, for example, thiodiethylene bis[3-(3,5-di-tert-butyl-4-hydroxyphenyl)propionate], 4,4′ -thiobis(2-tert-butyl-5-methylphenol), 2,2′ -thiobis(4-methyl-6-tert-butyl-phenol), benzenepropanoic acid, 3,5 bis (1,1 dimethylethyl)4-hydroxy benzenepropanoic acid, 3,5-bis(1,1-dimethylethyl)-4-hydroxy-C13-15 branched and linear alkyl esters, 3,5-di-tert-butyl-4 hydroxyhydrocinnamic acid C7-9-Branched alkyl ester, 2,4-dimethyl-6-t-butylphenol Tetrakis {methylene 3-(3′,5′-ditert-butyl-4′-hydroxyphenol)propionate}methane or Tetrakis {methylene 3-(3′,5′-ditert-butyl-4′-hydrocinnamate}methane, 1,1,3 tris (2-methyl-4 hydroxyl 5 butylphenyl)butane, 2,5, di t-amyl hydroqunone, 1,3,5-tri methyl 2,4,6 tris(3,5 di tert butyl 4 hydroxybenzyl) benzene, 1,3,5 tris(3,5 di tert butyl 4 hydroxybenzyl) isocyanurate, 2,2 Methylene-bis-(4-methyl-6-tert butyl-phenol), 6,6′-di-tert-butyl-2,2′-thiodi-p-cresol or 2,2′ -thiobis(4-methyl-6-tert-butylphenol), 2,2 ethylenebis (4,6-di-t-butylphenol), Triethyleneglycol bis{3-(3-t-butyl-4-hydroxy-5 methylphenyl) propionate}, 1,3,5 tris(4 tert butyl 3 hydroxy-2,6-dimethylbenzyl)-1,3,5-triazine-2,4,6-(1H,3H,5H)trione, 2,2 methylenebis{6-(1-methylcyclohexyl)-p-cresol}. Additionally, phenolic antioxidants disclosed in U.S. Pat. Nos. 4,020,042 and 6,869,995, which are incorporated herein by reference, are also appropriate for the present invention. Additionally Thio ester antioxidant co-stabilisers provide long term protection of the polymer. Lowinox® DLTDP and Lowinox® DSTDP are utilised in many applications as a synergist in combination with other phenolic antioxidants. The preferred phenolic antioxidants are thiodiethylene bis(3-(3,5-di-tert-4-butyl-4-hydroxyphenyl)propionate, pentaerythritol tetrakis(3-(3,5-di-tert-butyl-4-hydroxyphenyl)propionate, ethylenebis(oxyethylene)bis-(3-(5-tert-butyl-4-hydroxy-m-tolyl)-propionate and 4,6-bis(octylthiomethyl)o-cresol.

Peroxides are useful for crosslinking the polyolefin. Examples of the peroxide initiator include dicumyl peroxide; bis(alpha-t-butyl-peroxyisopropyl)benzene; isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3; 1,1-bis(t-butylperoxy)3,3,5-trimethylcyclohexane; isopropylcumyl cumylperoxide; di(isopropylcumyl) peroxide; and mixtures of two or more such initiators. Peroxide curing agents are used typically in amounts of 0.1 to 3, preferably 0.5 to 3, and even more preferably 1 to 2.5 percent by weight of the total composition. Various curing coagents (as well as boosters or retarders) can be used in combination with the peroxide initiator, and these include triallyl isocyanurate; ethoxylated bisphenol A dimethacrylate; α-methyl styrene dimer (AMSD); and the other co-agents described in U.S. Pat. Nos. 5,346,961 and 4,018,852, which are incorporated herein by reference. Coagents are used, if used at all, typically in amounts of greater than 0 (e.g., 0.01) to 3, preferably 0.1 to 0.5, and even preferably 0.2 to 0.4 percent.

The insulation compositions may optionally be blended with various additives that are generally used in insulted wires or cables, such as a metal deactivator, a flame retarder, a dispersant, a colorant, a stabilizer, and/or a lubricant, in the ranges where the object of the present invention is not impaired. The additives should be less than about 5 percent (by weight base on the total polymer), preferably less than about 3 percent, more preferably less than about 0.6 percent.

The metal deactivator, can include, for example, N,N-bis(3-(3,5-di-t-butyl-4-hydroxyphenyl)propionyl)hydrazine, 3-(N-salicyloyl)amino-1,2,4-triazole, and/or 2,2′-oxamidobis-(ethyl 3-(3,5-di-t-butyl-4-hydroxyphenyl)propionate).

The flame retarder, can include, for example, halogen flame retarders, such as tetrabromobisphenol A (TBA), decabromodiphenyl oxide (DBDPO), octabromodiphenyl ether (OBDPE), hexabromocyclododecane (HBCD), bistribromophenoxyethane (BTBPE), tribromophenol (TBP), ethylenebistetrabromophthalimide, TBA/polycarbonate oligomers, brominated polystyrenes, brominated epoxys, ethylenebispentabromodiphenyl, chlorinated paraffins, and dodecachlorocyclooctane; inorganic flame retarders, such as aluminum hydroxide and magnesium hydroxide; and/or phosphorus flame retarders, such as phosphoric acid compounds, polyphosphoric acid compounds, and red phosphorus compounds.

The stabilizer, can be, but is not limited to, hindered amine light stabilizers (HALS) and/or heat stabilizers. The HALS can include, for example, bis(2,2,6,6-tetramethyl-4-piperidyl)sebaceate (Tinuvin® 770); bis(1,2,2,6,6-tetramethyl-4-piperidyl)sebaceate+methyl1,2,2,6,6-tetrameth-yl-4-piperidyl sebaceate (Tinuvin® 765); 1,6-Hexanediamine, N,N′-Bis(2,2,6,6-tetramethyl-4-piperidyl)polymer with 2,4,6 trichloro-1,3,5-triazine, reaction products with N-butyl2,2,6,6-tetramethyl-4-piperidinamine (Chimassorb® 2020); decanedioic acid, Bis(2,2,6,6-tetramethyl-1-(octyloxy)-4-piperidyl)ester, reaction products with 1,1-dimethylethylhydroperoxide and octane (Tinuvin® 123); triazine derivatives (tinuvin® NOR 371); butanedioc acid, dimethylester, polymer with 4-hydroxy-2,2,6,6-tetramethyl-1-piperidine ethanol (Tinuvin® 622); 1,3,5-triazine-2,4,6-triamine,N,N′″-[1,2-ethane-diyl-bis[[[4,6-bis-[butyl(1,2,2,6,6pentamethyl-4-piperdinyl)amino]-1,3,5-triazine-2-yl]imino-]-3,1-propanediyl]]bis[N′,N″-dibutyl-N′,N″bis(2,2,6,6-tetramethyl-4-pipe-ridyl) (Chimassorb® 119); and/or bis (1,2,2,6,6-pentamethyl-4-piperidinyl) sebacate (Songlight® 2920); poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]] (Chimassorb®944); Benzenepropanoic acid, 3,5-bis(1,1-dimethyl-ethyl)-4-hydroxy-.C7-C9 branched alkyl esters (Irganox® 1135); and/or Isotridecyl-3-(3,5-di-tert-butyl-4-hydroxyphenyl) propionate (Songnox® 1077 LQ). The preferred HALS is bis(1,2,2,6,6-pentamethyl-4-piperidinyl) sebacate commercially available as Songlight 2920.

The heat stabilizer can be, but is not limited to, 4,6-bis (octylthiomethyl)-o-cresol (Irgastab KV-10); dioctadecyl 3,3′-thiodipropionate (Irganox PS802); poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]] (Chimassorb®944); Benzenepropanoic acid, 3,5-bis(1,1-dimethyl-ethyl)-4-hydroxy-.C7-C9 branched alkyl esters (Irganox® 1135); Isotridecyl-3-(3,5-di-tert-butyl-4-hydroxyphenyl) propionate (Songnox® 1077 LQ). If used, the preferred heat stabilizer is 4,6-bis (octylthiomethyl)-o-cresol (Irgastab KV-10); dioctadecyl 3,3′-thiodipropionate (Irganox PS802) and/or poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]] (Chimassorb®944).

The compositions of the invention can be prepared by blending the base polyolefin polymer, styrene copolymer, and additives by use of conventional masticating equipment, for example, a rubber mill, Brabender Mixer, Banbury Mixer, Buss-Ko Kneader, Farrel continuous mixer or twin screw continuous mixer. The additives are preferably premixed before addition to the base polyolefin polymer. Mixing times should be sufficient to obtain homogeneous blends. All of the components of the compositions utilized in the invention are usually blended or compounded together prior to their introduction into an extrusion device from which they are to be extruded onto an electrical conductor.

After the various components of the composition are uniformly admixed and blended together, they are further processed to fabricate the cables of the invention. Prior art methods for fabricating polymer cable insulation or cable jacket are well known, and fabrication of the cable of the invention may generally be accomplished by any of the various extrusion methods.

In a typical extrusion method, an optionally heated conducting core to be coated is pulled through a heated extrusion die, generally a cross-head die, in which a layer of melted polymer is applied to the conducting core. Upon exiting the die, if the polymer is adapted as a thermoset composition, the conducting core with the applied polymer layer may be passed through a heated vulcanizing section, or continuous vulcanizing section and then a cooling section, generally an elongated cooling bath, to cool. Multiple polymer layers may be applied by consecutive extrusion steps in which an additional layer is added in each step, or with the proper type of die, multiple polymer layers may be applied simultaneously.

The conductor of the invention may generally comprise any suitable electrically conducting material, although generally electrically conducting metals are utilized. Preferably, the metals utilized are copper or aluminum. In power transmission, aluminum conductor/steel reinforcement (ACSR) cable, aluminum conductor/aluminum reinforcement (ACAR) cable, or aluminum cable is generally preferred.

Without further description, it is believed that one of ordinary skill in the art can, using the preceding description and the following illustrative example, make and utilize the compounds of the present invention and practice the claimed methods. The following example is given to illustrate the present invention. It should be understood that the invention is not to be limited to the specific conditions or details described in this example.

### EXAMPLE 1

Square 14 gauge copper conductor wires with 30 mils of insulation were extruded with a 20:1 LD Davis standard extruder and a crosshead die and cured in steam under 230 psi pressure. 25 inch samples (n=20) of these insulated square conductor wires were placed in a 50° C. water bath and energized with 7500 volts until failure. Average and largest trees were determined. The purpose of the square conductor is to create an electrical stress concentration at each corner and accelerate time to failure.

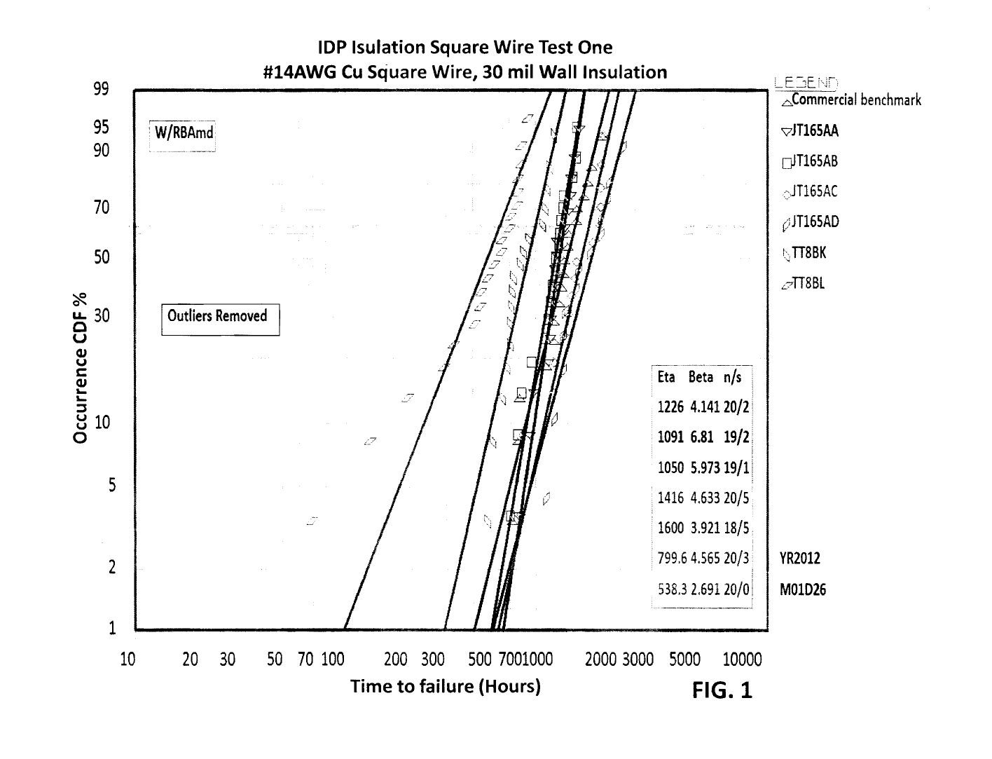

Table 1 and FIGS. 1-4 show the compositions and the square wire test and dielectric properties for each composition. The square wired test is performed as prescribed in the prior paragraph, breakdown strength is performed as prescribed by UL 2556 (2007), and the dielectric properties are determined in accordance to ASTM D150-9 (2004).

TABLE 1
Square wire test results for the compositions shown

| Insulation | TT6BK | TT6BL | C.M. | TMC1 | TMC2 | TMD | JT165AA | JT16AB | JT165AC | JT165AD |
|---|---|---|---|---|---|---|---|---|---|---|
| LDPE | 99.8 | 99.5 | | 97.2 | 97 | 94.7 | 98.7 | 97.2 | 98.7 | 97.2 |
| Entira MK400 | | | | | | | 1 | 2.5 | | |
| Entira AS500 | | | | | | | | | 1 | 2.5 |
| Pelestat 300 | | | | 2.5 | 2.5 | 5.0 | | | | |
| KV-10 | | 0.3 | | 0.3 | 0.3 | 0.3 | 0.3 | 0.3 | 0.3 | 0.3 |
| Songlite 2920 | 0.2 | 0.2 | | | 0.2 | | | | | |
| D-16 | 1.8 | 1.8 | | 1.8 | 1.8 | 1.8 | 1.8 | 1.8 | 1.8 | 1.8 |

Square Wire Test Results

| | | | | | | | | | | |
|---|---|---|---|---|---|---|---|---|---|---|
| Breakdown, kV | 33.9 | 29.5 | 32.7 | 28.9 | 32.4 | 25.5 | 34.59 | 36.02 | 24.92 | 31.24 |
| Weibul Mean Value, | 800 | 538 | 1226 | 1686 | 2186 | 1578 | 1091 | 1050 | 1416 | 1600 |
| hours | | | | | | | | | | |
| Weibull Beta Value | 4.57 | 2.69 | 4.24 | 8.2 | 4.88 | 8.44 | 6.81 | 5.97 | 4.63 | 3.92 |

Dielectric Properties

| | | | | |
|---|---|---|---|---|
| Dielectric Constant | 2.29 | 2.31 | 2.29 | 2.47 |
| @ RT | | | | |
| Dielectric Constant | 2.26 | 2.2 | 2.25 | 2.34 |
| @ 90° C. | | | | |
| Dielectric Constant | 2.03 | 1.96 | 2.05 | 2.15 |
| @ 140° C. | | | | |
| Dissipation Factor | 0.03 | 0.04 | 0.04 | 0.06 |
| @ RT | | | | |
| Dissipation Factor | 0.01 | 0.02 | 0.03 | 0.08 |
| @ 90° C. | | | | |

C.M. = Commercial Benchmark TRXLPE compound
LDPE = low density polyethylene
Entira MK400 = potassium inomer
Entira AS500 = potassium inomer
Pelestat 300 = polyethylene-polyether copolymer
KV-10 = 4,6-bis(octylthiomethyl)-o-cresol
Songlite 2920 = bis(1,2,2,6,6-pentamethyl-4-piperidinyl)sebacate
D-16 = tert-cumyl peroxide
RT = room temperature

FIGS. 1-4 show the square wire test results for the samples. Referring to FIG. 1, square wire test results are shown for different non-migrating antistatic agents with different loading level on a Weibull plot. In a square wire test, a conductor with square shaped cross-section is coated with the tested insulation, but the insulation has a circular shaped cross section. The thickness of insulation varies being thinnest near the corners of the square shaped conductor. The ordinate indicates the occurrence of capacitance discharge failure in percent on a logarithmic scale, and the abscissa indicates time in hours with logarithmic scale. Eta, beta and n/s values are provided in a legend on the plot. A beta value of less than 1 indicates infant mortality, and a beta value of greater than 1 indicates worn out failure. Similar beta values indicate similar failure modes. Cables are compared at their respective eta values which correspond to 63.2% of each cable's characteristic life. The n/s values are the ratios of data points sampled versus number of data points suspended due to an unrelated failure, such as an electrical disconnection instead of insulation failure. As shown, both JT165AC and JT165AD with higher eta values indicate that both cables take longer to fail than commercial tree retardant XLPE insulation.

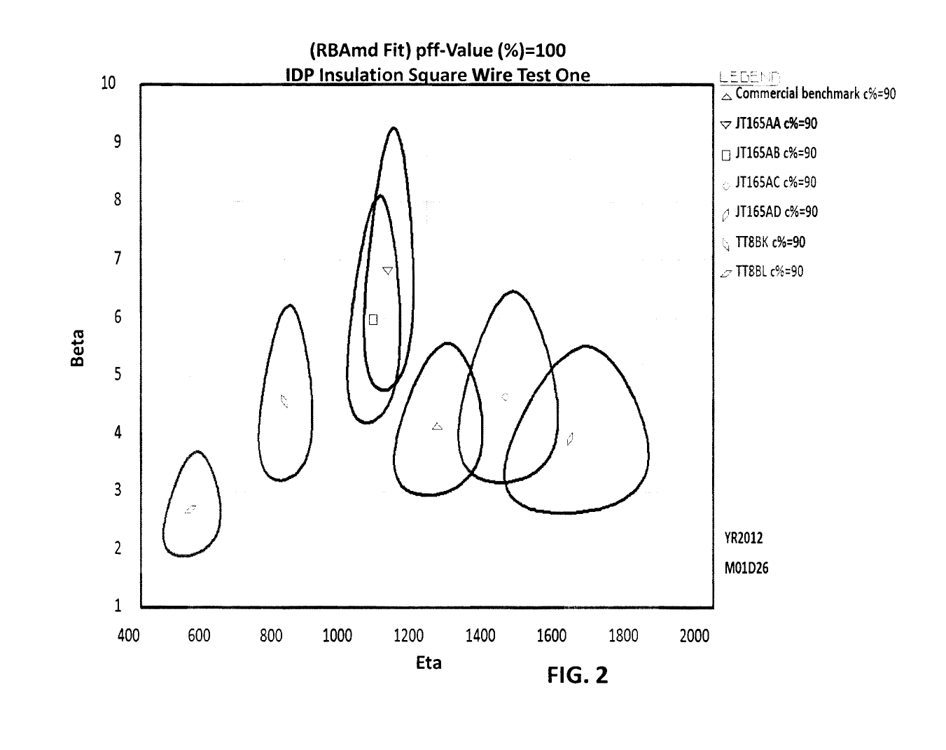

Referring to FIG. 2, cable lifetime-to-failure eta value difference in FIG. 1 among different cable insulations is shown on Weibull confidence contour plot with 90% double bound confidence. The ordinate indicates the beta value, and the abscissa indicates eta value. The gap between JT165AD and control plots indicates that JT165AD is statistically significantly different from control with 90% confidence, with a pff value of 100%; and JD165AD has a higher eta value. Overlap between JT165AC and control contours indicates that those two cables are not significantly different with 90% confidence, but JT165 wire has a higher eta value.

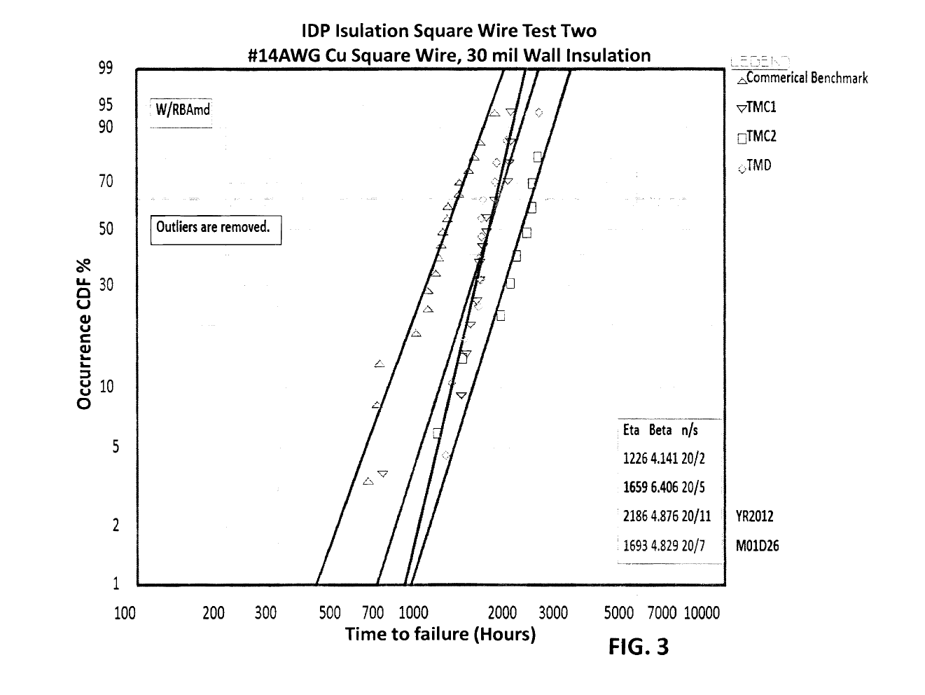

Referring to FIG. 3, square wire test results are shown for Pelestat antistatic agents with different loading level on a Weibull plot. As indicated in FIG. 1, the ordinate indicates the occurrence of capacitance discharge failure in percent on a logarithmic scale, and the abscissa indicates time in hours with logarithmic scale. Eta, beta and n/s values are provided in a legend on the plot. A beta value of less than 1 indicates infant mortality, and a beta value of greater than 1 indicates worn out failure. Similar beta values indicate similar failure modes. Cables are compared at their respective eta values which correspond to 63.2% of each cable's characteristic life. The n/s values are the rations of data points sampled versus number of data points suspended due to an unrelated failure, such as an electrical disconnection instead of insulation failure. As shown, TMC1, TMC2 and TMD with higher eta values indicate that cable insulation made with Pelestat takes longer to fail than commercial tree retardant XLPE insulation.

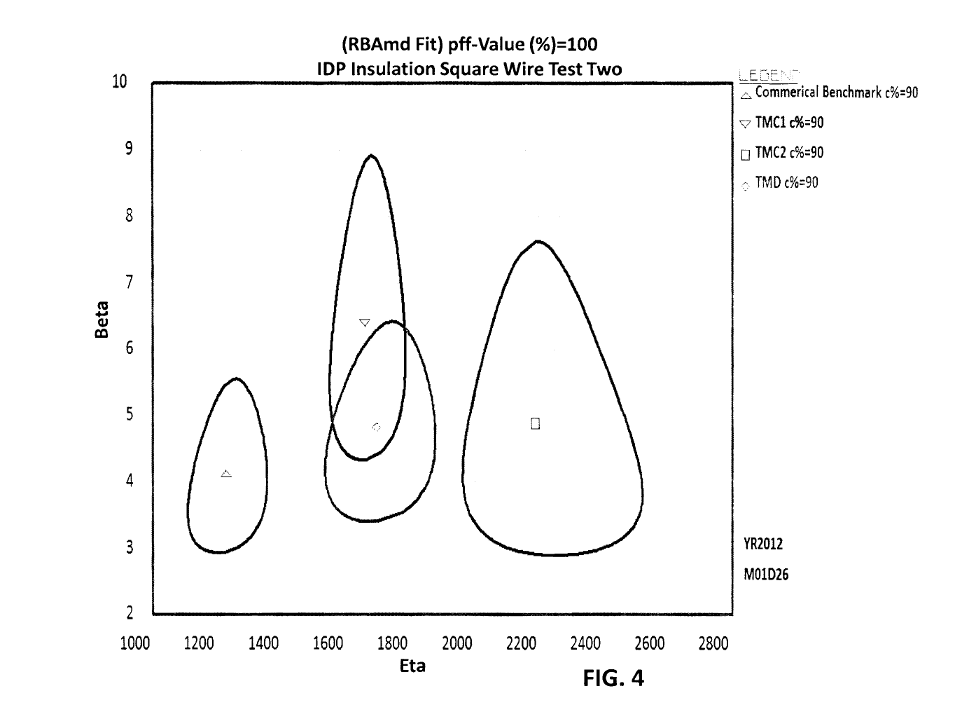

Referring to FIG. 4, cable lifetime-to-failure eta value difference in FIG. 3 among different cable insulations is shown on Weibull confidence contour plot with 90% double bound confidence. As indicated in FIG. 2, the ordinate indicates the beta value, and the abscissa indicates eta value. The gap among TMC1, TMC2, TMD and control contours indicates that TMC1, TMC2 and TMD are statistically significantly different from control with 90% confidence, with a pff value of 100%; and TMC1, TMC2 and TMD have higher eta value than commercial TRXLPE insulation. TMC2 with UV stabilizer is Songlight 2920 and is statistically significantly different from TMC 1 and TMD with a higher eta values. Overlap between TMC 1 and TMD contours indicates that these two cables are not significantly different with 90% confidence.

### EXAMPLE 2

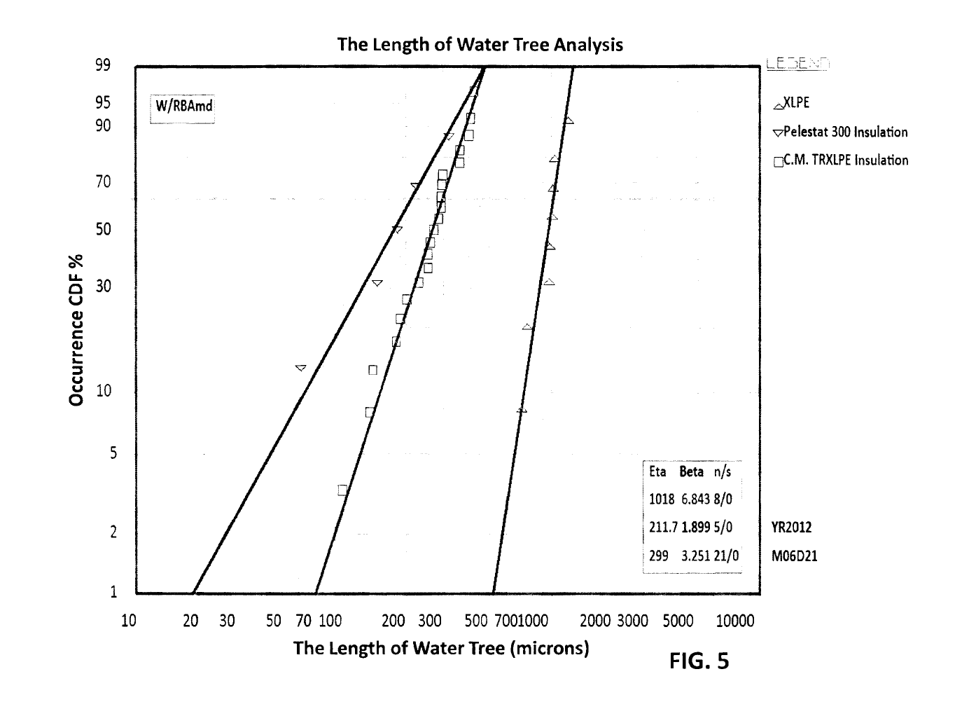

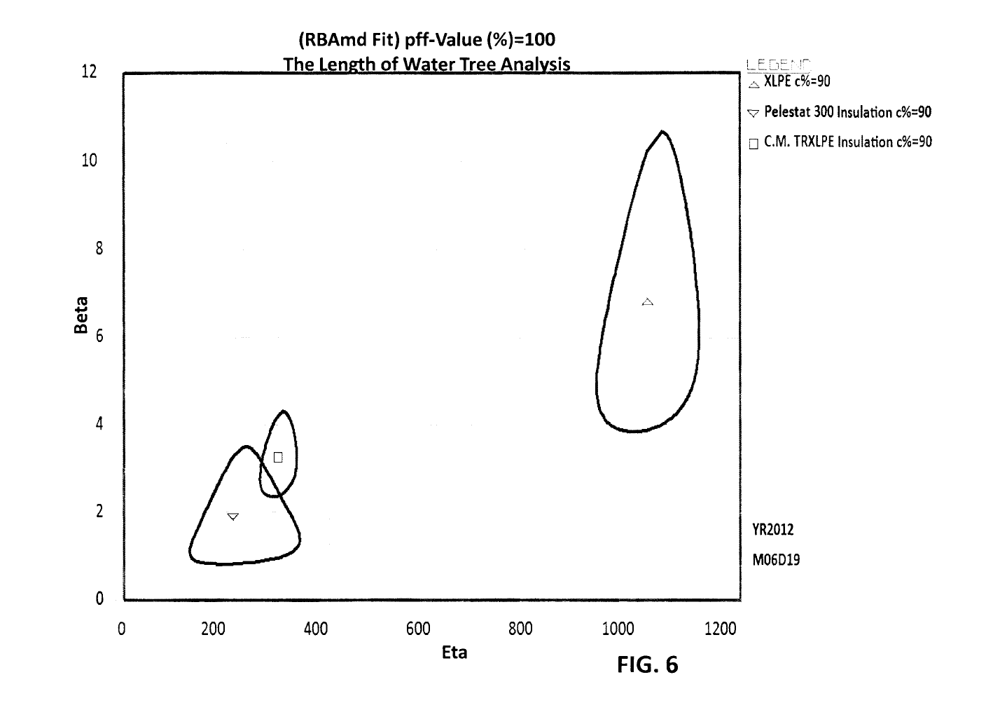

Table 2 and FIGS. 5-6 shows the compositions and the square wire test and dielectric properties for each composition. The square wired test is performed as prescribed above.

TABLE 2

| | | Pelestat 300 | |
|---|---|---|---|
| Formulation | XLPE | Insulation | C.M. |
| LDPE | 99.2 | 98.2 | |
| Pelestat 300 | | 1 | |
| Irganox 1035 | 0.2 | 0.2 | |
| Irganox | 0.5 | 0.5 | |
| PS802 | | | |
| Tinuvin 622 | 0.1 | 0.1 | |
| LD | | | |
| Di-cup | 1.8 | 1.8 | |

Irganox 1035 = Thiodiethylene bis[3-(3,5-di-tert--butyl-4-hydroxyphenyl)propionate]
Irganox 1035 = Dioctadecyl 3,3′-thiodipropionate
Tinuvin 622 LD = butanedioic, dimethylester, polymer with 4-hydroxy-2,2,6,6-tetramethyl-1-piperidine ethanol
Di-cup = Dicumyl Peroxide

Referring to FIG. 5, the difference in water tree growth rate among the three compositions (XLPE, insulation containing antistatic agent Pelestat 300 (Pelestat 300 Insulation), and CM) is shown on Weibull plot. The ordinate indicates the occurrence of water tree growth rate in percent on a logarithmic scale, and the abscissa indicates water tree length in mils with logarithmic scale. Eta, beta and n/s values are provided in a legend on the plot. Water tree growth rates of insulations are compared at their respective eta values which correspond to 63.2% of each insulation's characteristic length. The n/s values are the ratios of data points sampled versus number of data points suspended due to unrelated damage. As shown, insulation containing Pelestat has a much lower water tree length than natural crosslinking LDPE insulation and commercial water tree retardant cross-linking insulation.

Referring to FIG. 6, water tree length eta value difference among different insulations is shown on Weibull confidence contour plot with 90% double bound confidence. The ordinate indicates the beta value, and the abscissa indicates eta value. The gap between Pelestat 300 insulation and natural XLPE plots indicates that Pelestat 300 is statistically significantly different from natural XLPE with 90% confidence with a pff value of 100% and Pelestat 300 insulation has a lower eta value. Overlap between Pelestat 300 insulation and CM indicates that those two insulations are not significantly different with 90% confidence, but Pelestat 300 insulation has a lower eta value.

### EXAMPLE 3

1/0 AWG 15 kV cables were made with the insulations depicted in Table 3 and tested. Volume resistivity at room temperature, 90° C., and 140° C. and AC breakdown strength were determined in accordance with ANSI/ICEA S-94-649-2004.

TABLE 3

| | Pelestat | Entira | C.M. |
|---|---|---|---|
| Formulation | 300 | AS500 | Insulation |

| | | |
|---|---|---|
| LDPE | 98.2 | 98.2 |
| Pelestat 300 | 1 | |
| Entira AS 500 | | 1 |
| Irganox 1035 | 0.25 | 0.25 |
| Irganox PS802 | 0.25 | 0.25 |
| Tinuvin 622 LD | 0.2 | 0.2 |
| Lowinox TBP6 | 0.1 | 0.1 |
| Luperox D-16 | 1.8 | 1.8 |

Volume Resistivity (ohms-meter)

| | | | |
|---|---|---|---|
| Room temperature | 3.36 × 10¹⁶ | 1.54 × 10¹⁵ | 2.60 × 10¹⁵ |
| 90° C. | 1.04 × 10¹² | 4.34 × 10¹⁴ | 3.28 × 10¹³ |
| 140° C. | 1.61 × 10¹⁰ | 9.50 × 10⁹ | 8.55 × 10¹¹ |

ac Breadown strength, volts/mil

| | | |
|---|---|---|
| 783 | 686 | 786 |

Table 4 shows the retained breakdown strength of the 1/0 AWG 15 kV cables, (volts/mil) determined in accordance to ICEA S-94-649-2004.

TABLE 4

| | Wet Ageing Time, days | | | |
|---|---|---|---|---|
| | 0 | 30 | 60 | 90 |
| C.M. Insulation | 1127 | 1243 | 1183 | 1136 |
| Pelestat300 | 1083 | 1219 | 963.5 | 934.9 |
| AS500 | 1064 | 827.2 | 790.7 | 761 |

Tables 5-7 show the average dissipation factor for the 1/0 AWG 15 kV cables determined in accordance with ICEA S-94-649-2004.

TABLE 5
Average Dissipation Factor of Three Pelestat 300 Cable Samples

| | | | | ICEA Max |
|---|---|---|---|---|
| | Ambient | 105 C. | 140 C. | XLPE/TRXLPE |
| Week 0 | 0.017% | 0.019% | 0.169% | 0.500% |
| Week 1 | 0.115% | 0.022% | 0.088% | 0.500% |
| Week 2 | 0.137% | 0.068% | 0.090% | 0.500% |
| Week 3 | 0.137% | 0.177% | 0.248% | 0.500% |
| Week 4 | 0.143% | 0.204% | 0.250% | 0.500% |
| Week 5 | 0.141% | 0.203% | 0.246% | 0.500% |
| Week 6 | 0.131% | 0.197% | 0.246% | 0.500% |
| Week 7 | 0.140% | 0.192% | 0.227% | 0.500% |
| Week 8 | 0.134% | 0.196% | 0.245% | 0.500% |
| Week 9 | 0.149% | 0.197% | 0.253% | 0.500% |

Conclusion: Pelestat 300 cable passes dry electrical test at week 7 and 8 per Part 10.5.5.3 Electrical Measurements of ICEA S-94-649-2004.

TABLE 6
Average Dissipation Factor of Three Entira AS500 Cable Samples

| | | | | ICEA Max |
|---|---|---|---|---|
| | Ambient | 105 C. | 140 C. | XLPE/TRXLPE |
| Week 0 | 0.073% | 0.082% | 0.302% | 0.500% |
| Week 1 | 0.083% | 0.177% | 0.184% | 0.500% |
| Week 2 | 0.049% | 0.299% | 0.254% | 0.500% |
| Week 3 | 0.047% | 0.429% | 0.464% | 0.500% |
| Week 4 | 0.067% | 0.429% | 0.504% | 0.500% |
| Week 5 | 0.049% | 0.365% | 0.513% | 0.500% |
| Week 6 | 0.055% | 0.321% | 0.485% | 0.500% |
| Week 7 | 0.055% | 0.286% | 0.442% | 0.500% |
| Week 8 | 0.087% | 0.278% | 0.400% | 0.500% |
| Week 9 | 0.105% | 0.260% | 0.380% | 0.500% |

Conclusion: Entira AS500 cable passes dry electrical test at week 7 per Part 10.5.5.3 Electrical Measurements of ICEA S-94-649-2004.

TABLE 7
Average Dissipation Factor of Three CM Cable Samples

| | Ambient | 105° C. | 140° C. |
|---|---|---|---|
| Week 0 | 0.018% | 0.000% | 0.021% |
| Week 1 | 0.033% | 0.007% | 0.006% |
| Week 2 | 0.039% | 0.041% | 0.055% |
| Week 3 | 0.042% | 0.148% | 0.209% |
| Week 4 | 0.046% | 0.171% | 0.211% |
| Week 5 | 0.051% | 0.183% | 0.266% |
| Week 6 | 0.056% | 0.183% | 0.304% |
| Week 7 | 0.063% | 0.186% | 0.245% |
| Week 8 | 0.069% | 0.220% | 0.423% |
| Week 9 | 0.241% | 0.493% | 0.684% |

Conclusion: CM cable does not pass dry electrical test per Part 10.5.5.3 Electrical Measurements of ICEA S-94-649-2004.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A composition comprising a polyolefin polymer, a permanent antistatic agent, a phenolic antioxidant, and a peroxide.

2. The composition of claim 1, wherein the permanent antistatic agent is polyethylene-polyether copolymer, potassium ionomer, ethoxylated amine, or polyether block imides.

3. The composition of claim 1, wherein polyolefin polymer is polyethylene.

4. The composition of claim 1, wherein the phenolic antioxidant is thiodiethylene bis(3-(3,5-di-tert-4-butyl-4-hydroxyphenyl)propionate, pentaerythritol tetrakis(3-(3,5-di-tert-butyl-4-hydroxyphenyl)propionate, ethylenebis(oxyethylene)bis-(3-(5-tert-butyl-4-hydroxy-m-tolyl)-propionate, or 4,6-bis(octylthiomethyl)o-cresol.

5. The composition of claim 1, wherein the peroxide is dicumyl peroxide or tert-butyl cumyl peroxide.

6. The composition of claim 1, further comprising at least one additive.

7. The composition of claim 6, wherein the at least one additive is selected from the group consisting of a metal deactivator, a flame retarder, a dispersant, a colorant, a stabilizer, a peroxide, and a lubricant.

8. The composition of claim 7, wherein the stabilizer is bis (1,2,2,6,6-pentamethyl-4-piperidinyl) sebacate, 4,6-bis (octylthiomethyl)-o-cresol, or dioctadecyl 3,3′-thiodipropionate.

9. The composition of claim 1, wherein the polyolefin polymer is present at about 90 -99 percent by weight of total composition.

10. The composition of claim 1, wherein the permanent antistatic agent is present at about 5-5 percent by weight of total composition.

11. The composition of claim 1, wherein the phenolic antioxidant is present at about 0.2-1.5 percent by weight of total composition.

12. The composition of claim 1, wherein the peroxide is present at about 1.5-2.5 percent by weight of total composition.

13. A cable comprising a conductor and a covering made of the material of claim 1.

14. The cable of claim 8, wherein the covering is an insulation or a jacket.

15. The composition of claim 1, wherein the permanent antistatic agent is polyethylene-polyether copolymer, potassium ionomer, ethoxylated amine, or polyether block imides.

16. The composition of claim 1, wherein polyolefin polymer is polyethylene.

17. The composition of claim 1, wherein the phenolic antioxidant is thiodiethylene bis(3-(3,5-di-tert-4-butyl-4-hydroxyphenyl)propionate, pentaerythritol tetrakis(3-(3,5-di-tert-butyl-4-hydroxyphenyl)propionate, ethylenebis(oxyethylene)bis-(3-(5-tert-butyl-4-hydroxy-m-tolyl)-propionate, or 4,6-bis(octylthiomethyl)o-cresol.

18. The composition of claim 1, wherein the peroxide is dicumyl peroxide or tert-butyl cumyl peroxide.

19. A method for making a cable comprising the steps of
a. providing a conductor; and
b. covering the conductor with the material of claim 1.

20. The method of claim 17, wherein step b is used to make an insulation or a jacket.
